(19) United States
(12) Patent Application Publication
(10) Pub. No.: US 2015/0172324 A1
(43) Pub. Date: Jun. 18, 2015

(54) Authorized SIP Redirection

(71) Applicant: Alcatel-Lucent USA Inc., Murray Hill, NJ (US)

(72) Inventors: James A. Calme, Aurora, IL (US); Angelica T. Remoquillo, Naperville, IL (US)

(73) Assignee: Alcatel-Lucent USA Inc., Murray Hill, NJ (US)

(21) Appl. No.: 14/106,576

(22) Filed: Dec. 13, 2013

(51) Int. Cl. H04L 29/06

(52) U.S. Cl. CPC H04L 65/1046; H04L 65/1069; H04L 65/1006

(57) ABSTRACT

Method and apparatus for authorized Session Initiation Protocol (SIP) redirection are provided. A first SIP INVITE request is received at a destination server. A first target server of a set of target servers for further processing of redirected load is determined. The first target server is for further processing associated with the first SIP INVITE request. A redirection response including Universal Resource Identifiers (URIs) identifying the first target server and a Redirection Authorization Key (RAK) is sent. Inclusion of a valid RAK in a SIP INVITE is checked by a target server. If a valid RAK is not include in SIP INVITE, the SIP INVITE is denied.

### FIELD OF THE INVENTION

The invention relates generally to the redistribution of incoming call traffic across multiple local servers.

### BACKGROUND

This section introduces aspects that may help facilitate a better understanding of the inventions. Accordingly, the statements of this section are to be read in this light and are not to be understood as admissions about what is prior art or what is not prior art.

Session initiation protocol (SIP) messaging is known. Such messaging is used for controlling communication sessions over internet protocol (IP) networks. SIP messages are sent between peers or network nodes and these messages govern the establishment and termination of a call between network nodes as set out in the Internet Engineering Task Force (IETF) Request for Comments (RFC) 3261. Although the session initiation protocol enables calls to be established between user clients, unexpected consequences can occur. Accordingly, it is desired to provide improved techniques for such messaging.

### SUMMARY

SIP redirection is existing technology that can be used to distribute the traffic across local servers. However, conventional SIP mechanisms do not guarantee that the traffic received by the local servers is the direct result of an authorized redirection. Accordingly, embodiments herein provide a methodology and mechanism to redistribute authorized incoming call traffic across multiple local servers. Embodiments herein also provide a methodology and mechanism by which local servers can verify the authorization validity of the incoming call traffic.

In one embodiment, an apparatus comprises a redirection server and a set of target servers for further processing of redirected load; the redirection server comprising a processor and an associated memory. The processor is configured to receive a first Session Initiation Protocol (SIP) INVITE request from a requestor, determine a first target server of the set of target servers, the first target server for further processing associated with the first SIP INVITE request, and forward a redirection response to the requestor, the redirection response including Universal Resource Identifiers (URIs) indicating the first target server and a Redirection Authorization Key (RAK).

In one embodiment, the RAK is a string. In one embodiment, the RAK is unique to the apparatus. In one embodiment, the RAK is unique for a single use. In one embodiment, the RAK is valid for a limited time interval. In one embodiment, the RAK is cryptographically encoded or includes a signature. In one embodiment, the RAK is a concatenation of an address of the first target server, an instance identification, and a current timestamp.

In one embodiment, the first target server comprises a first target processor and a first target associated memory, with the first target processor configured to receive a second SIP INVITE request and process the second SIP INVITE request based on inclusion of the RAK in the second SIP INVITE.

In one embodiment, the first target processor is configured to process the second SIP INVITE request based on validity of the RAK in the second SIP INVITE. In one embodiment, when the second SIP INVITE is valid, the first target processor is configured to perform further processing based the second SIP INVITE. In one embodiment, when the second SIP INVITE is not valid, the first target processor is configured to deny the second SIP INVITE.

In one embodiment, the redirection response includes a contact header comprising a username at a Fully Qualified Domain Name (FQDN) or an Internet Protocol (IP) address.

In one embodiment, the processor is configured to utilize a load balancing algorithm to determine the first target server.

One embodiment of a method of Session Initiation Protocol (SIP) redirection includes receiving a first SIP INVITE request, determining a first target server of a set of target servers for further processing of redirected load, the first target server for further processing associated with the first SIP INVITE request, and sending a redirection response including Universal Resource Identifiers (URIs) identifying the first target server and a Redirection Authorization Key (RAK).

The RAK may be at least one of a string, unique to the apparatus, unique for a single use, valid for a limited time interval, cryptographically encoded, and include a signature. In one embodiment, the RAK is a concatenation of an address of the first target server, an instance identification, and a current timestamp.

In one embodiment, the method includes receiving a second SIP INVITE request and processing the second SIP INVITE request based on inclusion of the RAK in the second SIP INVITE. The method may also check the validity of the RAK in the second SIP INVITE based on correspondence of the RAK to a specific keyword, prior use of the RAK in a SIP INVITE, and timeliness of the second SIP INVITE. In one embodiment, further processing is performed if the second SIP INVITE is valid. In one embodiment, the second SIP INVITE is denied if the second SIP INVITE is not valid.

In one embodiment, the method is embodied in a tangible processor-readable medium, the tangible processor-readable medium excluding signals and storing a set of instructions which when executed by a processor perform any one of the above described methods.

In one embodiment, a network node for a communication system is configured to communicate with other network nodes and network equipment in the system. The network node includes a processor and an associated memory unit, with the processor configured to perform any one of the above described methods.

### BRIEF DESCRIPTION OF THE DRAWINGS

One or more embodiments will now be described further, with reference to the accompanying drawings, in which:

FIG. 1 is a depiction of signaling flow in accordance with one or more embodiments of the invention;

FIG. 2 is a logic flow diagram of a method for authorizing Session initiation protocol (SIP) redirection in accordance with one or more embodiments of the invention; and

FIG. 3 depicts a high-level block diagram of a computer suitable for use in performing methodology described herein.

Specific embodiments of the invention are disclosed below with reference to the Figures. Both the description and the illustrations have been drafted with the intent to enhance understanding. For example, the dimensions of some of the figure elements may be exaggerated relative to other elements, and well-known elements that are beneficial or even necessary to a successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the described embodiments in view of what is already known in the art. One of skill in the art will appreciate that various modifications and changes may be made to the specific embodiments described below without departing from the spirit and scope of the invention. Thus, the specification and drawings are to be regarded as illustrative and exemplary rather than restrictive or all-encompassing, and all such modifications to the specific embodiments described below are intended to be included within the scope of the invention.

### DETAILED DESCRIPTION OF EMBODIMENTS

To provide a greater degree of detail in making and using various embodiments of the invention, a description of the approach taken to communications in networks, and a description of certain, quite specific, embodiments follows for the sake of example.

For example, a redirection authorization key may be provided in the Session Initiation Protocol (SIP) Universal Resource Identifier (URI) returned by a redirect server. This redirection authorization key can be echoed back in the resulting SIP INVITE to a local server. The redirection authorization key can then be checked at local servers to ensure that a received SIP INVITE has been properly authorized. Any unauthorized traffic can then be denied or given a different treatment based on usage of the redirection authorization key.

The SIP protocol [see RFC 3261] may be used as the call control protocol between switches. SIP is based on a request/response transaction model. Each transaction comprises a request that invokes a particular method, or function, on the server and at least one response. A transaction begins with calling party (e.g., Alice's softphone) sending an INVITE request addressed to a called party (e.g., Bob's SIP URI). INVITE is an example of a SIP method that specifies the action that the requestor (Alice) wants the server (Bob) to take. The INVITE request contains a number of header fields. Header fields are named attributes that provide additional information about a message. SIP URIs have a similar form to an email address, typically containing a username and a host name.

A destination switch may wish to load share the processing of calls across multiple local servers associated with the destination switch, each local server having its own address and/or port, for example, an Internet Protocol (IP) address. To accomplish this desired load sharing, the destination switch could distribute the call traffic internal to the local servers. However, performing this functionality may consume additional resources required for handling the initial incoming call, for providing communication associated with the call between servers, and additionally for managing the call in the targeted server.

An alternative solution to address load sharing which can serve to increase signaling path robustness is for the destination switch to implement a SIP Redirect Server based on existing technology in order to direct the originating switch on how to route the call to a targeted server. Redirection allows servers to push routing information for a request back in a response to the client, thereby taking themselves out of the loop of further messaging for this transaction while still aiding in locating the target of the request. When the originator of the request receives the redirection, it will send a new request based on the URI(s) it has received. The redirect server provides a location service that is effectively a database containing mappings between a single URI and a set of one or more alternative locations at which the target of that single URI can be found.

When using the conventional SIP protocol, this implementation would be realized through the originating switch initiating the call by sending a SIP INVITE request to the destination switch. The INVITE is a SIP method that specifies the action that the requester (e.g., calling party, originating switch, and the like) wants the server (e.g., called party, destination switch, and the like) to take. The destination switch would then determine a target server for the call from a set of target servers (e.g., a plurality of potential target servers) and redirect the call to that target server by returning a Redirection response (e.g., 3xx response) containing a Contact header field with an address that uniquely identifies the target server. The Contact header field tells other elements where to send future requests. The Contact header field contains a SIP or SIPS URI, usually composed of a username at a Fully Qualified Domain Name (FQDN), though since many end systems do not have registered domain names, an IP addresses are also permitted.

Redirection responses (e.g., 3xx responses) give information about a new location, or about alternative services that might be able to satisfy the call. When the originating switch receives the Redirection response, the address from the Contact header field will be used by the originating switch to initiate a new SIP INVITE request directed to the targeted server.

Embodiments of the invention further enable the destination switch to accept only calls that it has explicitly redirected to the target servers that it manages. Note that the redirect server has the responsibility for correct distribution of traffic across the target servers through the use of a load balancing algorithm. Thus, allowing external nodes to freely direct calls to the target servers could/would disrupt the intended traffic distribution determined by the destination switch which in turn impacts/disrupts the engineered processor occupancy. Accordingly, embodiments provided herein propose that any calls not a direct result of the destination switch redirection (i.e., authorized by the destination switch) be denied.

Currently existing standardized technology in the existing SIP redirection procedures does not permit the target server to know that a newly received call (e.g., SIP INVITE request) is a direct result the destination switch's load sharing mechanism. Thus, the embodiments provided herein define a new URI parameter, Redirection Authorization Key (RAK) that may be included by the redirect server function and examined by a target server.

Standard processing by the originating switch is to accept the entire URI received, including any URI parameters, in the Redirection response Contact header field and place that entire URI in the new SIP INVITE request for routing purposes. Depending on the SIP response type (e.g., 302 vs. 305), the target URI will be placed in the Request-URI or Route header field of a new SIP INVITE request, respectively. According to one or more embodiments of the invention, when a target server receives the SIP INVITE request, it examines the RAK and verifies the validity of the RAK. Only SIP INVITE requests with a valid RAK are accepted by target servers; all other SIP INVITE requests are denied.

Redirection responses include 300:Multiple Choices, 301:Moved Permanently, 302:Moved Temporarily, 305:Use Proxy, and 380:Alternative Service. The 300:Multiple Choices response indicates that the address in the request resolved to several choices, each with its own specific location, and that the user (or user agent (UA)) can select a preferred communication end point and redirect its request to that location. The 301:Moved Permanently response indicates that the user can no longer be found at the address in the Request-URI, and that the requesting client should retry at the new address given by the Contact header field. The 302:Moved Temporarily response indicates that the requesting client should retry the request at the new address(es) given by the Contact header field. The 305:Use Proxy response indicates that the requested resource must be accessed through the proxy given by the Contact field. The 380:Alternative Service response indicates that the call was not successful, but alternative services are possible with the alternative services being described in the message body of the response.

The RAK may be any string. However, to avoid misuse, the RAK should be generated in a manner that makes RAK unique to the generating switch. For example, the RAK may be a unique keyword for each switch (i.e. a keyword unique to the generating network element). For example, the RAK may include an instance identifier that limits that RAK to a single use. The redirection would be allowed so long as the instance identifier has not already be used to authorize the servicing of a redirection.

To avoid misuse, the RAK also should be generated in a manner that makes RAK valid for a limited time interval. For example, the RAK may include a timestamp which indicates the starting time from which the redirected INVITE will be valid. The redirection would be allowed from the time of the timestamp to some future time, e.g., 64*T1 seconds later. Given a T1 of 500 ms at the destination server means that the RAK is available for authorizing the servicing of a redirection anytime within that 32 second window. It may also desirable that the RAK be able to be recognized as having a valid, acceptable value by the target sever without the RAK having to be directly exchanged between the redirect server and the target server. Further, it may be desirable that the RAK be cryptographically encoded. For example, the redirect server and target server could both have knowledge of a shared key used to encrypt the RAK. External nodes would have difficulty being able to independently generate the same RAK making such circumvention of the RAK mechanism difficult. As an alternative to encrypting the RAK, the RAK could be signaled in the clear and a digital signature provided in the 3xx redirection response that is also repeated from the INVITE. However, this approach would require that the signature rotate to avoid replay. One example RAK is a cryptographically encoded concatenation of the target server IP address, instance identification, and a current timestamp.

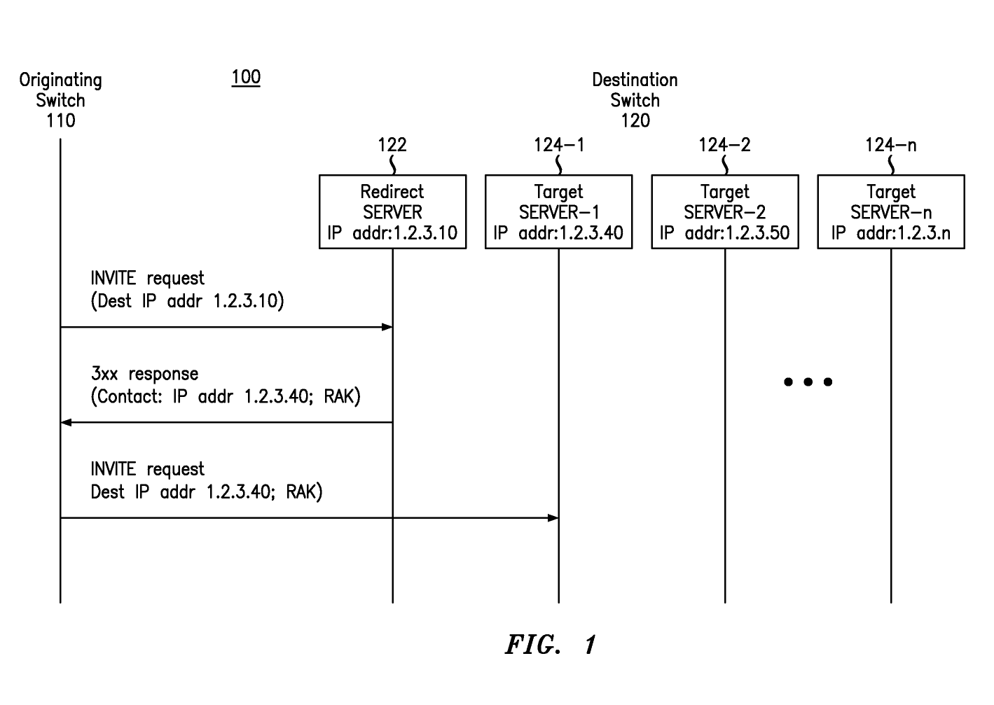

FIG. 1 is a depiction of signaling flow in accordance with one or more embodiments of the invention. FIG. 1 illustrates a network 100 including a plurality of switches which utilize the SIP protocol as the call control protocol between the switches. Originating switch 110 initiates the call by sending a SIP INVITE request, which specifies the action that the requester (e.g., calling party, originating switch, and the like) wants the server (e.g., called party, destination switch, and the like). The SIP INVITE request is forwarded to destination switch 120. Destination switch 120 includes a 122 redirection server and a set of target servers 124-1, 124-2, . . . 124-n (e.g., a plurality of target servers) that the destination switch can utilize to handle call processing. Each of the redirection server and target servers are addressable via an IP address. For example, the redirection server 122 is addressed at IP address 1.2.3.10, the first target server 124-1 is addressed at IP address 1.2.3.40, the second target server 124-2 is addressed at IP address 1.2.3.50, and the n-th target server 124-n is addressed at IP address 1.2.3.n. Originating switch 110 initially contacts the destination switch via redirection server 122. For example, the first SIP INVITE request associated with a call is directed to the IP address of the redirection server. The destination switch 120, here redirection server 122, then determines a target server for handling the call from the set of target servers 124-1, 124-2, . . . 124-n. The target server is determined using a load balancing algorithm. The redirection server 122 redirects the call to a specific target server by returning a Redirection response (e.g., 3xx response) containing a Contact header field with an address that uniquely identifies the target server to which the requestor network element is to send a future request associated with the first SIP INVITE request. As illustrated, the Contact header field includes the IP addresses for the first target server 124-1 which has been identified for further processing associated with this call. The redirection response also includes a Redirection Authorization Key (RAK). The RAK indicates that the redirection is authorized. The RAK may be one or more of a string, unique to the apparatus, valid for a single use, valid for a limited time interval, include a signature, and cryptographically encoded. For example, the RAK may be a concatenation of an address of the first target server, an instance identification, and a current timestamp.

The originating switch 110 then sends a SIP INVITE to the target server (e.g., 124-1) to which it has been redirected. The SIP INVITE sent to the target server includes the RAK received from the redirection server in order that the target server can check the authorization status of the originating switch to make and have fulfilled the request.

The target server (e.g., 124-1) receives this second SIP INVITE request and processes this second SIP INVITE request based on inclusion of the RAK in the second SIP INVITE. If a SIP INVITE request received by a target server does not include a RAK, the SIP INVITE request is denied. The target server can further check the validity of the RAK to determine whether to fulfill the request. When the SIP INVITE is valid, the first target server will perform further processing based the second SIP INVITE. When the SIP INVITE is not valid, the first target server will deny the second SIP INVITE. The validity check may include determining that the RAK has an expected value and/or determining that RAK utilized is not older than a threshold age. For example, a target server may determine that no more than a threshold amount of time has passed since the timestamp in a RAK and thus that the RAK is valid. For example, a target server may determine that the current time is earlier than the time indicated by the timestamp in a RAK and thus that the RAK is valid. The validity check may also include determining if this RAK instance has previously been received by comparing the instance identification against previous received values within the allowed timeframe.

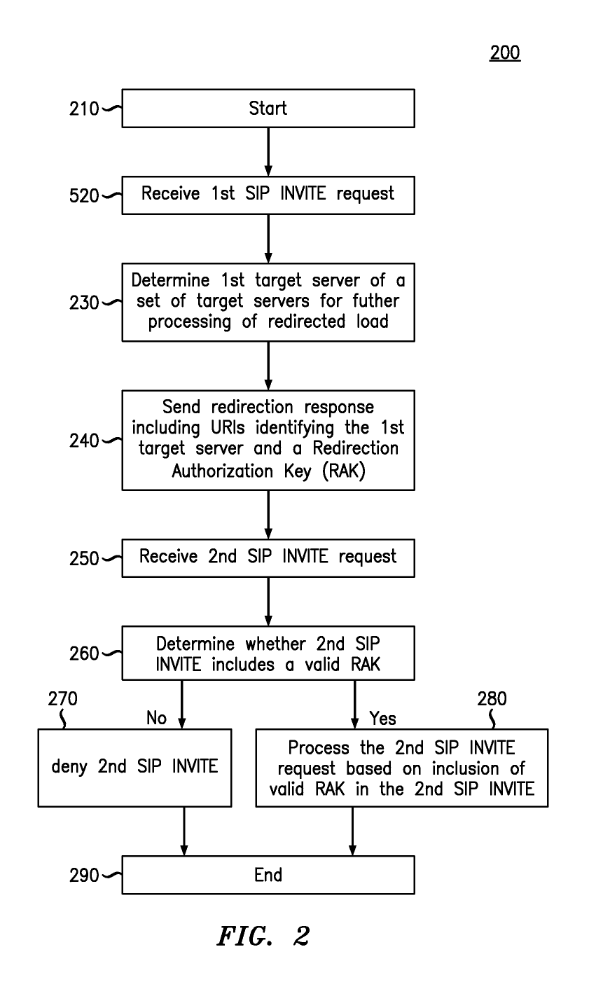

FIG. 2 is a logic flow diagram of a method for authorizing Session Initiation Protocol (SIP) redirection in accordance with one or more embodiments of the invention. The detailed and, at times, very specific descriptions are provided to effectively enable a person of skill in the art to make, use, and best practice one or more embodiments of the invention in view of what is already known in the art. In the examples, specifics are provided for the purpose of illustrating possible embodiments of the invention and should not be interpreted as restricting or limiting the scope of the broader inventive concepts. Other embodiments may be implemented in which the method and logic flow above may be modified.

The example method 200 begins at operation 210. At operation 220, a destination switch receives a first SIP INVITE request from a requestor.

At operation 230, the destination switch determines a first target server of a set of target servers for further processing of redirected load associated with the first SIP INVITE request. The first target server may be the server selected for further processing associated with the first SIP INVITE request according to a load balancing algorithm. For example, the first target server may be selected randomly from the set, the first target server may be selected from the set in a round-robin fashion, the first target server may be selected based on processor capacity availability of the target servers of the set, and the like.

At operation 240, the destination server sends a redirection response to the requestor. The redirection response includes Universal Resource Identifiers (URIs) identifying the first target server and a Redirection Authorization Key (RAK).

At operation 250, the destination server receives a second SIP INVITE request.

At operation 260, the destination server (e.g., the first target server of the set of target servers) determines whether the second SIP INVITE request includes a valid RAK. This determination may involved one or more of checking for inclusion in the RAK of a specific keyword, inclusion in the RAK of an instance identification that has not previously been used to authorize a SIP INVITE request, and receipt of the RAK within a timeframe. Based on whether the second SIP INVITE request includes a valid RAK, the destination server may take further action.

At operation 270, the destination server processes the second SIP INVITE request based on inclusion of a valid RAK in the second SIP INVITE.

At operation 280, the destination server denies the second SIP INVITE when a valid RAK is not included in the second SIP INVITE.

At operation 290, the example method ends.

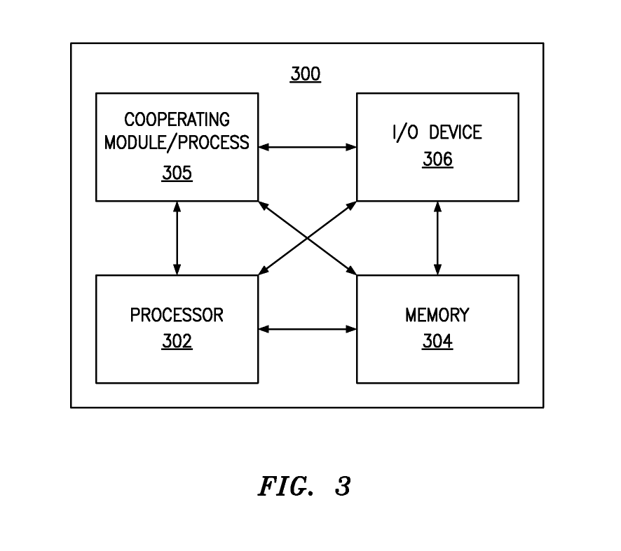

FIG. 3 depicts a high-level block diagram of a computer suitable for use in performing the operations and methodology described herein. The computer 300 includes a processor 302 (e.g., a central processing unit (CPU) or other suitable processor(s)) and a memory 304 (e.g., random access memory (RAM), read only memory (ROM), and the like).

The computer 300 also may include a cooperating module/process 305. The cooperating process 305 can be loaded into memory 304 and executed by the processor 302 to implement functions as discussed herein and, thus, cooperating process 305 (including associated data structures) can be stored on a computer readable storage medium, e.g., RAM memory, magnetic or optical drive or diskette, and the like.

The computer 300 also may include one or more input/output devices 306 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 300 depicted in FIG. 3 provides a general architecture and functionality suitable for implementing functional elements described herein or portions of functional elements described herein. For example, the computer 300 provides a general architecture and functionality suitable for implementing one or more of FIG. 2's originating switch 110, destination switch 120, redirect server 122, target servers 124-1, 124-2, 124-n, and the like.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of one or more of the methods described herein. The program storage devices may be non-transitory media, e.g., digital memories, magnetic storage media such as a magnetic disks or tapes, hard drives, or optically readable digital data storage media. In one or more embodiments, tangible medium excluding signals may include a set of instructions which when executed are operable to perform one or more of the descried methods. The provided embodiments are also intended to be embodied in computers programmed to perform said steps of methods described herein.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms ‘a’ or ‘an’, as used herein, are defined as one or more than one. The term “plurality”, as used herein, is defined as two or more than two. The term “another”, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

1. An apparatus comprising a redirection server and a set of target servers for further processing of redirected load, the redirection server comprising a processor and an associated memory, the processor configured to
receive a first Session Initiation Protocol (SIP) INVITE request from a requestor;
determine a first target server of the set of target servers, the first target server for further processing associated with the first SIP INVITE request; and
forward a redirection response to the requestor, the redirection response including Universal Resource Identifiers (URIs) indicating the first target server and a Redirection Authorization Key (RAK).

2. The apparatus of claim 1, wherein the RAK is a string.

3. The apparatus of claim 1, wherein the RAK is unique to the apparatus.

4. The apparatus of claim 1, wherein the RAK is unique for a single use.

5. The apparatus of claim 4, wherein the RAK is valid for a limited time interval.

6. The apparatus of claim 5, wherein the RAK is cryptographically encoded.

7. The apparatus of claim 5, wherein the RAK is a concatenation of an address of the first target server, an instance identification, and a current timestamp.

8. The apparatus of claim 1 wherein the first target server comprises a first target processor and a first target associated memory, the first target processor configured to
receive a second SIP INVITE request;
process the second SIP INVITE request based on inclusion of the RAK in the second SIP INVITE.

9. The apparatus of claim 7 wherein the first target processor is configured to
process the second SIP INVITE request based on validity of the RAK in the second SIP INVITE;
wherein when the second SIP INVITE is valid, the first target processor is configured to perform further processing based the second SIP INVITE, and
when the second SIP INVITE is not valid, the first target processor is configured to deny the second SIP INVITE.

10. The apparatus of claim 1 wherein the redirection response includes a contact header comprising a username at a Fully Qualified Domain Name (FQDN) or an Internet Protocol (IP) address.

11. The apparatus of claim 1, wherein the processor is configured to utilize a load balancing algorithm to determine the first target server.

12. A method of Session Initiation Protocol (SIP) redirection, the method comprising:
receiving at a destination server a first SIP INVITE request;
determining at the destination server a first target server of a set of target servers for further processing of redirected load, the first target server for further processing associated with the first SIP INVITE request; and
sending from the destination server a redirection response, the redirection response including Universal Resource Identifiers (URIs) identifying the first target server and a Redirection Authorization Key (RAK).

13. The method of claim 12, wherein the RAK is unique to the destination server.

14. The method of claim 12, wherein the RAK is unique for a single use.

15. The method of claim 14, wherein the RAK is valid for a limited time interval.

16. The method of claim 15, wherein the RAK is cryptographically encoded.

17. The method of claim 15, wherein the RAK is a concatenation of an address of the first target server, a current timestamp, and an instance identification.

18. The method of claim 12, the method further comprising:
receiving a second SIP INVITE request;
processing the second SIP INVITE request based on inclusion of the RAK in the second SIP INVITE.

19. The method of claim 18 wherein said processing the second SIP INVITE request based on inclusion of the RAK in the second SIP INVITE comprises
processing the second SIP INVITE request based on validity of the RAK in the second SIP INVITE; and
when the second SIP INVITE is valid, performing further processing based the second SIP INVITE, and
when the second SIP INVITE is not valid, denying the second SIP INVITE.

20. The method of claim 12 wherein the redirection response includes a contact header comprising a username at a Fully Qualified Domain Name (FQDN) or an Internet Protocol (IP) address.

21. The method of claim 12, wherein the processor is configured to utilize a load balancing algorithm to determine the first target server.

22. A tangible processor-readable medium, the tangible processor-readable medium excluding signals, the tangible processor-readable medium storing a set of instructions which when executed by a processor perform a method, the method comprising:
receiving at a destination server a first SIP INVITE request;
determining at the destination server a first target server of a set of target servers for further processing of redirected load, the first target server for further processing associated with the first SIP INVITE request; and
sending from the destination server a redirection response, the redirection response including Universal Resource Identifiers (URIs) identifying the first target server and a Redirection Authorization Key (RAK).
